(19) United States
(12) Patent Application Publication
(10) Pub. No.: US 2017/0079413 A1
(43) Pub. Date: Mar. 23, 2017

(54) MIXING AND DISPENSING APPARATUS

(71) Applicant: Miguel Guerrero, Tucson, AZ (US)

(72) Inventor: Miguel Guerrero, Tucson, AZ (US)

(21) Appl. No.: 15/262,585

(22) Filed: Sep. 12, 2016

Related U.S. Application Data
(60) Provisional application No. 62/220,516, filed on Sep. 18, 2015.

(51) Int. Cl. A45F 3/20; A45F 3/04; B01F 13/00; B01F 15/02; B01F 15/00

(52) U.S. Cl. CPC A45F 3/20; B01F 15/0292; B01F 15/00824; B01F 13/0023; A45F 3/04; B01F 2215/0022; A45F 2003/166

(57) ABSTRACT

A mixing and dispensing apparatus configured to be used in conjunction with a hydration backpack or similar liquid containments are disclosed. The apparatus comprises a reservoir containing a solvent positioned within the hydration backpack. The apparatus further comprises a housing with cartridges, which is in fluid communication with the reservoir via an inlet tube attached to one end of the housing. The cartridge configured to store a solute, which is in fluid communication with the housing via a mixing interface positioned on each cartridge. The opposing end of the housing is attached to an outlet tube, aiding in fluid communication with the housing. The cartridge is pressurized to allow the solute to be extruded through the mixing interface, thereby dissolving the solute with the solvent within the housing. A bite valve is distally positioned to the outlet tube, in which a user suctions the bite valve to allow the transfer of the dissolved solution to a user's mouth.

### CROSS REFERENCE TO RELATED APPLICATIONS

This application claims priority to U.S. Provisional Patent Application No. 62/220,516, filed in the United States Patent and Trademark Office on Sep. 18, 2015. The specification of the above referenced patent application is incorporated herein by reference in its entirety.

### BACKGROUND OF THE INVENTION

A. Technical Field

The present invention generally relates to the technical field apparatus configured for mixing and dispensing, and more specifically relates to an apparatus for selectively introducing and mixing solutes into a solution (solvent), which is integrated into a tubing of a hydration pack.

B. Description of Related Art

A hydration pack is a type of hydration system built as a backpack or waist pack containing a reservoir or pouch commonly made of, for example, rubber or flexible plastic. The reservoir contains a capped mouth for filling with liquid and a hose that allows the water or liquid to be consumed hands-free. Most hoses terminate with a bite valve that opens when the user bites down on it. Generally, hydration packs are found especially useful in rough and treacherous terrains.

Users of hydration packs range from civilians, i.e hikers and bikers, to military personnel, i.e., soldiers in combat as well as search and rescue teams. As such, situations arise when civilian hydration pack users are faced with scenarios where dehydration, hunger and fatigue set in. Taking breaks to consume food or resting to regain their energy is not an option. Soldiers involved in combat are faced with similar situations where they lack in nutrients and energy, which are essential for their well-being or even mere survival. The search and rescue teams in particular are often faced with scenarios where they may have to search for an individual for countless hours without rest or sleep. A viable option for the ingestion of nutrients on the go in extreme conditions does not exist.

There currently exists an option of mixing a powdered supplement into a solution in order to provide nutrients and energy with their hydration. However, this option proves problematic because of contamination to the hydration pack, which would then require thorough cleaning for further use. Additionally, the process of mixing a powdered supplement into the water is found to be inconvenient, messy, and impossible in extreme conditions.

Therefore, there is a need in the art for an apparatus to provide a means of selectively introducing the solute into the solvent flow sip by sip without contaminating the hydration pack in its entirety. Furthermore, there is a need in the art for such an apparatus to provide a source for nutrient rich water in a quick, clean, and efficient manner

### SUMMARY OF THE INVENTION

The present invention is a mixing and dispensing apparatus or pressurized solutes dispenser attached to a hydration pack such as hydration backpack or waist pack. The mixing and dispensing apparatus comprises a reservoir containing a solvent positioned within a hydration backpack. The apparatus of the present invention further comprises a housing attached on a shoulder strap of the hydration backpack. The housing is positioned to be in fluid interaction with the reservoir via an inlet tube attached to one end of the housing. The housing is set up to hold one (or more) configured to hold cartridges, each of which are purposed to store nutritional supplement, or a non-nutritional supplement, or concentrated food, or an energy producing substance, or an alcohol, or a fluid substance, or a gas phase substrates, or carbon dioxide or hydrogen. These cartridges are positioned to interact with the solution housing via a mixing interface placed on each cartridge.

The opposing end of the housing is attached to an outlet tube. Additionally, the user has the ability to cut the outlet tube to size, depending on the use. When the user engages the housing on the pressurized cartridge, the solvent from the reservoir flows out and allows the solute to be extruded through the mixing interface, thereby mixing the solute in the solvent within the housing compartment. A bite valve is distally positioned to the outlet tube, so that a user suctions the bite valve to allow the transfer of the mixed solution to the user's mouth.

In an embodiment, the solvent is water and the solute contains a nutritional supplement, or a non-nutritional supplement, or concentrated food, or an energy producing substance, or an alcohol, or a fluid substance, or a gas phase substrates, or carbon dioxide or hydrogen. In an embodiment, the mixing interface is an opening, wherein the solute is extruded from the cartridge via the opening due to the pressurized cartridge. In another embodiment, the cartridge wall is made of metal. In another embodiment, the cartridge wall is coated with a non-corrosive material. In another embodiment, the cartridge wall is made from a group of materials comprising one of polymeric and elastomeric materials.

In another embodiment, the mixing interface is a release valve, wherein the solute is extruded from the metallic cartridge via the release valve by the opening of the release valve due to light force applied by the user on the cartridge. In another embodiment, the mixing interface is a discharge orifice, wherein the solute is extruded from the pressurized cartridge via the discharge orifice. In one embodiment, the mixing interface is a one-way valve, wherein the solute is extruded from the cartridge via the one-way valve due to the pressurized cartridge in the housing.

In an embodiment, the inlet tube is attached to the end of the housing via an inlet nipple, and the outlet tube is attached to the opposing end of the housing via an outlet nipple. In one embodiment, the inlet nipple and outlet nipple comprises ridges, wherein the ridges are configured to facilitate snug fitting of the inlet tube and the outlet tube to the inlet nipple and outlet nipple. In one embodiment, the apparatus further includes a cartridge holder defined by the housing configured to receive and position one or more cartridges.

In another embodiment, a mixing and dispensing apparatus configured to be use in a bottle is disclosed. The mixing and dispensing apparatus comprises a reservoir, a housing, and an outlet. The reservoir is positioned within the bottle containing a solvent. The housing is attached on a cap of the bottle, and the housing is in fluid communication with the reservoir via an inlet tube attached to one end of the housing. In one embodiment, the housing is configured to house one or more cartridges. Each cartridge is configured to store a solute, and the cartridge is in fluid communication with the housing via a mixing interface positioned on each cartridge.

The outlet of the cap is attached to an opposing end of the housing, and the outlet of the cap is in fluid communication with the housing. The cartridge is pressurized to allow the solute to be extruded through the mixing interface, thereby dissolving the solute with the solvent within the housing. The outlet of the cap is configured to be suction by a user, wherein the dissolved solution in the housing is transferred to the user's mouth. In one embodiment, the solvent is water and the solute is a nutritional supplement, or a non-nutritional supplement, or concentrated food, or an energy producing substance, or an alcohol, or a fluid substance, or a gas phase substrates, or carbon dioxide or hydrogen. In one embodiment, the outlet of the cap is a mouthpiece of the cap. In an embodiment, the mixing interface is a one-way valve, wherein the solute is extruded from the cartridge via the one-way valve due to the pressurized cartridge in the housing.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 shows a front perspective view of the mixing and dispensing apparatus positioned frontally to a hydration backpack according to an embodiment.

FIG. 2A shows a side perspective view of the housing with a cartridge in the apparatus.

FIG. 2B shows a front-side elevational view of the cartridge comprising an opening according to an embodiment.

FIG. 2C shows a side perspective view of the housing comprising a cartridge with a one-way valve in the apparatus according to an embodiment.

FIG. 2D shows a front-side perspective view of the mixing and dispensing apparatus in the bottle according to an embodiment.

FIG. 3A shows a front-side elevational view of the cartridge comprising a release valve according to an alternate embodiment.

FIG. 3B shows a bottom-side elevational view of the cartridge comprising a release valve.

FIG. 4 shows a front-side elevational view of the cartridge comprising a discharge orifice according to a different embodiment.

FIG. 5 shows a right-side elevational view of the housing comprising a cartridge with the inlet tube and outlet tube according to a different embodiment.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that evolve within the meaning and range of equivalency of the claims are to be embraced within their scope.

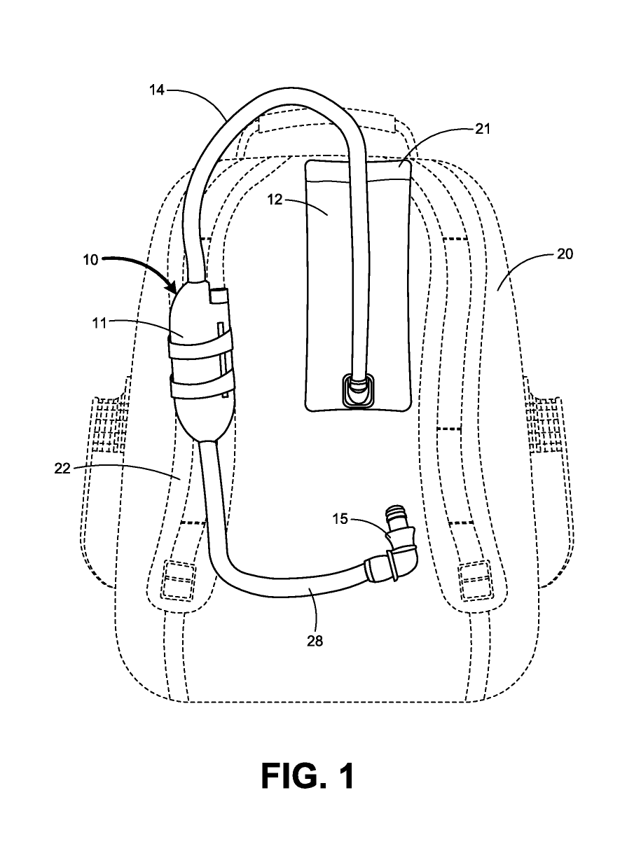

The present invention is directed to a mixing and dispensing apparatus 10 or pressurized solutes dispenser attached to a hydration pack such as hydration backpack or waist pack 20. Referring to FIG. 1 showing a perspective view of the mixing and dispensing apparatus 10 implemented in a hydration pack 20. In an embodiment, the mixing and dispensing apparatus 10 comprises a reservoir 21, which is positioned within the hydration backpack 20 containing a solvent 12. The mixing and dispensing apparatus 10 of the present invention further comprises a housing 11 attached on a shoulder strap 22 of the backpack 20. In one embodiment, the housing 11 could be attached to any supporting component of the backpack 20, thus making the housing 11 accessible for a user. In an embodiment, the housing 11 is positioned to be in fluid communication with the reservoir 21 via an inlet tube 14. One end of the inlet tube 14 is connected to the reservoir 21 of the backpack 20, and the opposing end of the inlet tube 14 is attached to an end of the housing 11.

In an embodiment, the opposing end of the housing 11 is attached to an outlet tube 28, which aids in fluid communication of the outlet tube 28 with the housing 11. A bite valve 15 is distally positioned to the outlet tube 28, where a user suctions the bite valve 15 to allow the transfer of the dissolved solution to a user's mouth. In one embodiment, the bite valve 15 is distally attached to the outlet tube 28 (via an airtight frictional fit). In one embodiment, the user may place the bite valve 15 in the user's mouth and, by biting on the bite valve 15, cause the bite valve 15 to move from a closed position to an open position allowing the solution to flow towards the user's mouth.

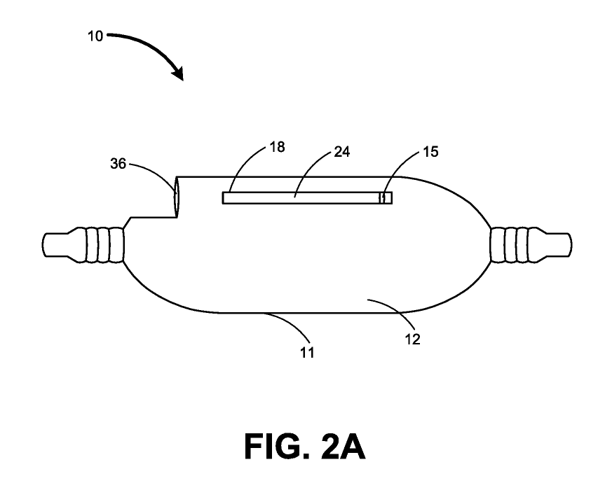

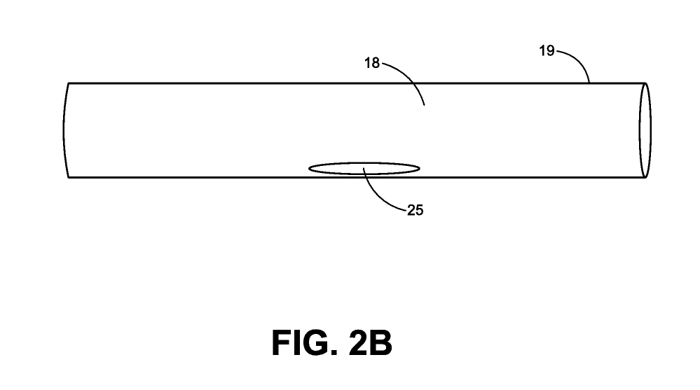

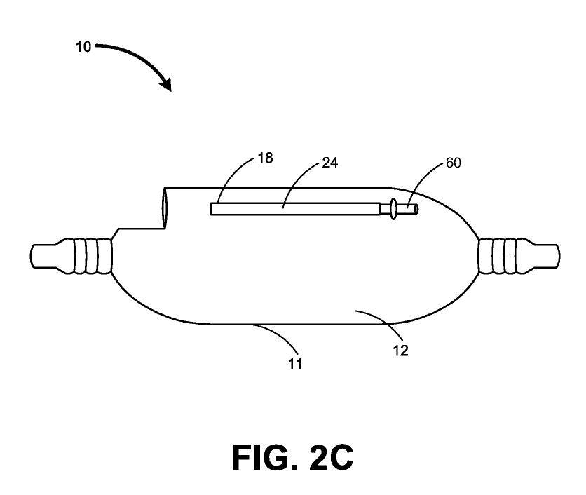

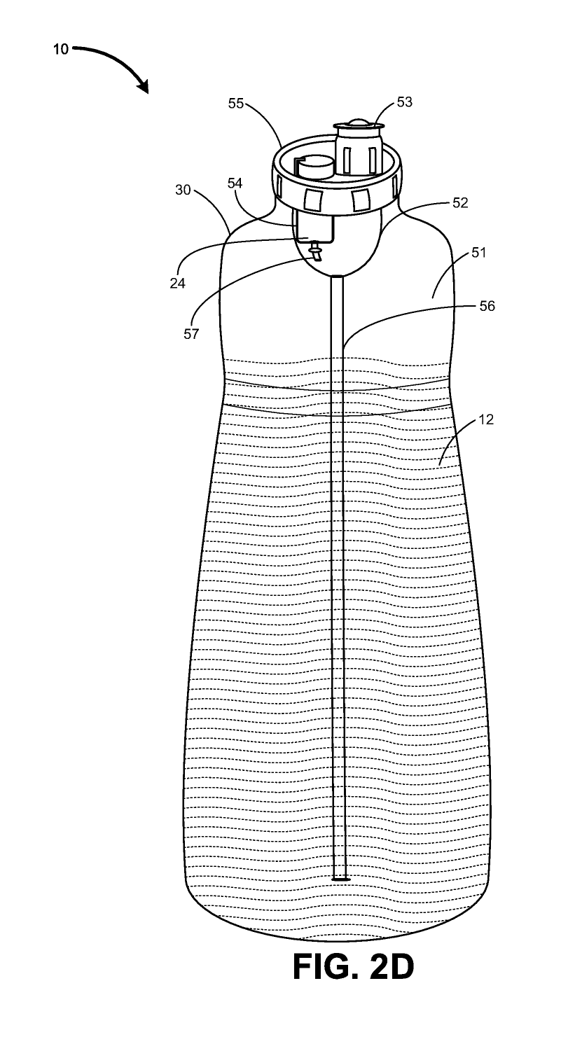

FIG. 2A shows a front-side elevational view of the housing 11 with a cartridge 18 in the mixing and dispensing apparatus 10. In one embodiment, the housing 11 is configured to encase multiple cartridges 18. In one embodiment, the mixing and dispensing apparatus 10 may further include a cartridge holder 36 defined by the housing configured to receive and position the cartridges 18. In one embodiment, the cartridge holder 36 is a cavity configured to mount the cartridges 18. The cartridge 18 is positioned to face the inner wall of the housing 11. In another embodiment, the cartridge holder 36 comprises holes opening internally towards the housing 11, such as, pores or orifices, which allow the transfer of one or more solutes 24 from the cartridge 18 to the housing 11. In one embodiment, the cartridge holder 36 is positioned on a side of the housing 11.

In an embodiment, each cartridge 18 is configured to store the solutes 24. In one embodiment, the cartridges 18 filled with the solute 24, are positioned to be in fluid communication with the housing 11 via a mixing interface 15. In one embodiment, the mixing interface 15 is positioned on each cartridge 18 allow the transferring and mixing of the solute 24 from the cartridge 18 to the solvent 12 which is filled in the housing 11. In an embodiment, when the cartridge 18 is empty, the cartridge 18 could be refilled with the solute 24 again. In one embodiment, the cartridge 18 is pressurized to allow the solute 24 to be extruded through the mixing interface 15, thereby dissolving the solute 24 with the solvent or solution 12 within the housing 11. In an embodiment, the solvent 12 is water, and the solute 24 is nutritional supplement, or a non-nutritional supplement, or concentrated food, or an energy producing substance, or an alcohol, or a fluid substance, or a gas phase substrates, or carbon dioxide or hydrogen.

FIG. 2B shows a front-side elevational view of the cartridge comprising an opening according to an embodiment. In one embodiment, the mixing interface 15 is an opening 25 and the solute 24 is extruded from the cartridge 18 via the opening 25 due to the pressurized cartridge 18 in the housing 11 as shown in FIG. 2A. In an embodiment, the cartridge wall 19 is made of metal. In one embodiment, the cartridge wall 19 is coated with a non-corrosive material to prevent corrosion. In another embodiment, the cartridge wall 19 is made from a group of materials comprising one of polymeric and elastomeric materials.

FIG. 2C shows a front-side elevational view of the housing 11 with a cartridge 18 in the mixing and dispensing apparatus 10. In an embodiment, the mixing interface 15 is a one-way valve 60, wherein the solute 24 is extruded from the cartridge via the one-way valve 60 due to the pressurized cartridge 18 in the housing 11. In one embodiment, the one-way valve 60 in the apparatus 10 is similar to the one-way valve on the existing water bottle cap design as shown in FIG. 2D.

In another embodiment, a mixing and dispensing apparatus 10 configured to be use in a bottle 30 is disclosed. The mixing and dispensing apparatus 10 comprises a reservoir 51, a housing 52, and an outlet 53. The reservoir 51 is positioned within the bottle 30 containing a solvent 12. The housing 52 is attached on a cap 55 of the bottle, and the housing 52 is in fluid communication with the reservoir 51 via an inlet tube 56 attached to one end of the housing 52. In one embodiment, the housing 52 is configured to house one or more cartridges 54. Each cartridge 54 is configured to store the solute 24, and the cartridge 54 is in fluid communication with the housing 52 via a mixing interface 57 positioned on each cartridge 54.

The outlet 53 of the cap 55 is attached to an opposing end of the housing 52, and the outlet 53 of the cap 55 is in fluid communication with the housing 52. The cartridge 54 is pressurized to allow the solute 24 to be extruded through the mixing interface 57, thereby dissolving the solute with the solvent 12 within the housing 52. The outlet 53 of the cap 55 is configured to be suction by a user, wherein the dissolved solution in the housing 52 is transferred to the user's mouth. In one embodiment, the solvent 12 is water and the solute 24 is a nutritional supplement, or a non-nutritional supplement, or concentrated food, or an energy producing substance, or an alcohol, or a fluid substance, or a gas phase substrates, or carbon dioxide or hydrogen. In one embodiment, the outlet 53 of the cap 55 is a mouthpiece of the cap 55. In an embodiment, the mixing interface 57 is a one-way valve, wherein the solute is extruded from the cartridge 54 via the one-way valve due to the pressurized cartridge 54 in the housing 52.

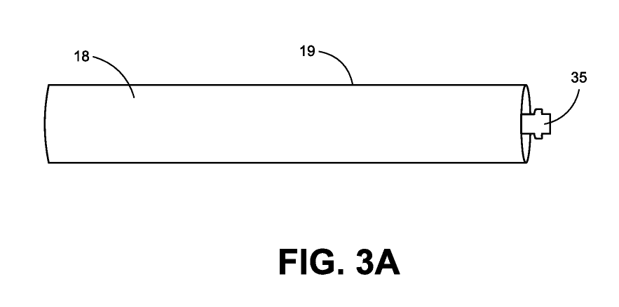

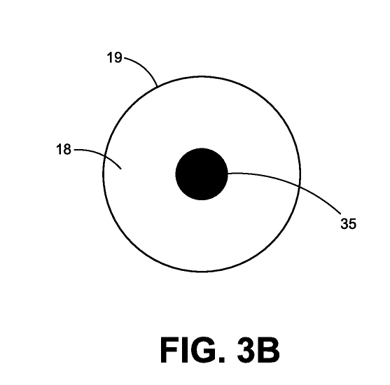

FIG. 3A and FIG. 3B shows a front side and bottom-side elevational view of the cartridge 18 comprising a release valve 35 according to an embodiment of the present invention. In one embodiment, the mixing interface 15 is a release valve 35 and the solute 24 is extruded from the metallic cartridge 18 by the opening of the release valve 35 due to the pressurized cartridge 18 in the housing 11 as shown in FIG. 2A. In one embodiment, the release valve 35 is positioned at the center of the bottom of the cartridge 18. In one embodiment, the release valve 35 is affixed to the cartridge holder 36 fits snugly inside the holder 36 as shown in FIG. 2A. In one embodiment, the cartridge wall 19 is made of rigid material, preferably metallic material containing the pressurized liquid solution of nutritional supplement, or a non-nutritional supplement, or concentrated food, or an energy producing substance, or an alcohol, or a fluid substance, or a gas phase substrates, or carbon dioxide or hydrogen. The rigidity of the cartridge wall 19 helps to maintain the high-pressure system for the liquid solution of nutritional supplement, or a non-nutritional supplement, or concentrated food, or an energy producing substance, or an alcohol, or a fluid substance, or a gas phase substrates, or carbon dioxide or hydrogen within the cartridge 18.

In an embodiment, the release valve 35 opens up a passage by the release of the pressurized cartridge 18. The valve 35 releases the pressurized liquid solution of nutritional supplement, or a non-nutritional supplement, or concentrated food, or an energy producing substance, or an alcohol, or a fluid substance, or a gas phase substrates, or carbon dioxide or hydrogen, to reduce the internal pressure of the cartridge 18. The liquid solution of nutritional supplement, or a non-nutritional supplement, or concentrated food, or an energy producing substance, or an alcohol, or a fluid substance, or a gas phase substrates, or carbon dioxide or hydrogen flows out of the passage and enters into the housing 11 as shown in FIG. 2A, filled with water. For example, a carbonation process, dissolving or mixing of carbon dioxide in water. When the pressurized cartridge 18 is released, the release valve 35 releases the passage for the liquid solution of nutritional supplement, or a non-nutritional supplement, or concentrated food, or an energy producing substance, or an alcohol, or a fluid substance, or a gas phase substrates, or carbon dioxide or hydrogen, to flow through into the housing 11. For example, a carbonation process, dissolving or mixing of carbon dioxide in water.

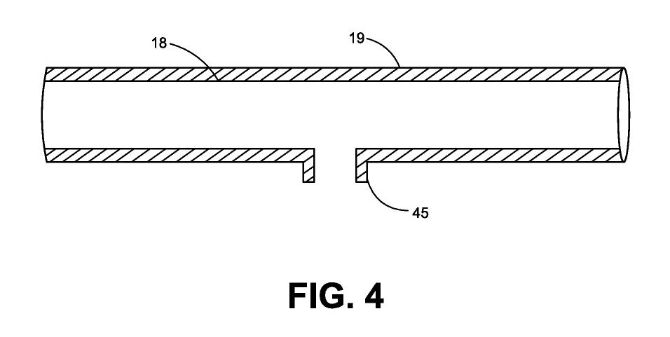

FIG. 4 shows a front side elevational view of the cartridge 18 comprising a discharge orifice 45 according to an embodiment of the present invention. In one embodiment, the mixing interface 15 is a discharge orifice 45 and the solute 24 is extruded from the cartridge 18 via the discharge orifice 45 due to the pressurized cartridge 18 in the housing 11 as shown in FIG. 2A. The release of the pressure in the pressurized cartridge 18 in the housing 11 through the discharge orifice 45 output the liquid solution of nutritional supplement, or a non-nutritional supplement, or concentrated food, or an energy producing substance, or an alcohol, or a fluid substance, or a gas phase substrates, or carbon dioxide or hydrogen. The release of the pressure in the pressurized cartridge 18 forces the liquid solution of the nutritional supplement, or a non-nutritional supplement, or concentrated food, or an energy producing substance, or an alcohol, or a fluid substance, or a gas phase substrates, or carbon dioxide or hydrogen, through the discharge orifice 45, and dispense the liquid solution into the housing 11 filled with water. For example, a carbonation process, dissolving or mixing of carbon dioxide in water. The opening or the discharge orifice 45 is closed such that the pressure is equalized between the interior of the cartridge 18 and the interior of the housing 11.

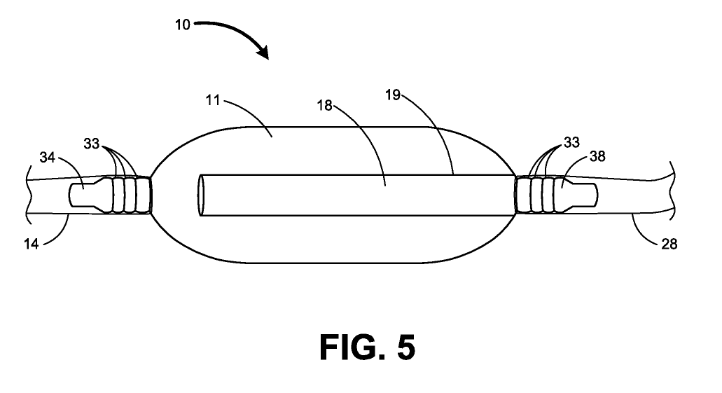

FIG. 5 shows a side elevational view of the housing 11 comprising a cartridge 18 with the inlet tube 14 and outlet tube 28. In an embodiment, the inlet tube 14 is attached to the end of the housing 11 via an inlet nipple 34, and the outlet tube 28 is attached to the opposing end of the housing 11 via an outlet nipple 38. In one embodiment, the inlet nipple 34 is located at the top of the housing 11 and the outlet nipple 38 is located at the bottom of the housing 11. In one embodiment, the inlet nipple 34 is the entrance of the mixing and dispensing apparatus 10 for the water flowing from the reservoir 21 of the hydration pack 20 as shown in FIG. 1. The outlet nipple 38 is the exit for the diluted liquid solution of nutritional supplement, or a non-nutritional supplement, or concentrated food, or an energy producing substance, or an alcohol, or a fluid substance, or a gas phase substrates, or carbon dioxide or hydrogen. In one embodiment, the inlet nipple 34 serves as an attachment piece for the inlet tube 14 and the mixing and dispensing apparatus 10 to allow a continual flow of water from the reservoir 21 as shown in FIG. 1, to the mixing and dispensing apparatus 10.

In one embodiment, the inlet nipple 34 and outlet nipple 38 comprises ridges 33 and the ridges 33 are configured to facilitate snug fitting of the inlet tube 14 and the outlet tube 28 to the inlet nipple 34 and outlet nipple 38. In one embodiment, the ridges 33 are positioned on an outer circumferential surface of the inlet nipple 34 and outlet nipple 38. In one embodiment, ridges 33 on the inlet nipple 34 and outlet nipple 38 acts as a fastener for the inlet tube 14 and the outlet tube 28. In another embodiment, the ridges 33 are configured to facilitate airtight frictional fit to the inlet nipple 34 and outlet nipple 38, which allows the user to pull the inlet tube 14 and outlet tube 28 out of the inlet nipple 34 and outlet nipple 38.

In one embodiment, the mechanics of mixing of the liquid solution of nutritional supplement, or a non-nutritional supplement, or concentrated food, or an energy producing substance, or an alcohol, or a fluid substance, or a gas phase substrates, or carbon dioxide or hydrogen, or any solute with the water, or any solvent collected in the housing 11 is disclosed. When the water flows out of the inlet nipple 34 into the housing 11, the water flowing out of the inlet nipple 34 transitions from a laminar flow to a turbulent flow due to a rapid variation of flow velocity. The cross-sectional area of the housing 11 is significantly larger than the cross-sectional area of the inlet nipple 34. This significant increase in cross-sectional area causes a rapid decrease in flow velocity and thus causes the flow to transition to a turbulent flow, which provides diffusivity. This turbulent flow allows the liquid solution of nutritional supplement, or a non-nutritional supplement, or concentrated food, or an energy producing substance, or an alcohol, or a fluid substance, or a gas phase substrates, or carbon dioxide or hydrogen, to be diffused at an accelerated rate, allowing the water, or any solvent to dilute the concentrated liquid solution. For example, a carbonation process, dissolving or mixing of carbon dioxide in water.

In various embodiments, cartridge 18 of the apparatus 10 comprises one or more solutes including nutritional supplement, or a non-nutritional supplement, or concentrated food, or an energy producing substance, or an alcohol, or a fluid substance, or a gas phase substrates, or carbon dioxide or hydrogen, or any solutes. In various embodiments, the solvent flowing within the housing 11 of the apparatus 10 comprises one or more solvents including water, carbonated water or any solvents.

The advantage of the mixing and dispensing apparatus 10 is selectively replenishing the water flowing out of the reservoir with liquid solution of concentrated food or any fluid rather than the concentrated food or any fluid to the entire supply of water within the reservoir of the hydration pack. The placement of the mixing and dispensing apparatus outside the reservoir prevents the liquid solution from contaminating the hydration pack and the supply of water contained within the hydration pack. Additionally, the present invention allows the user to dispense the desired amount of concentrated food, energy producing substance, or any substance into the water or any solvent at any given time and allows the user to have access to both nutrient rich water and pure water.

The foregoing descriptions comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Although specific terms may be employed herein, they are used only in generic and descriptive sense and not for purposes of limitation. Accordingly, the present invention is not limited to the specific embodiments illustrated herein.

What is claimed is:

1. A mixing and dispensing apparatus configured to be used in a hydration backpack, the mixing and dispensing apparatus comprising:
a reservoir positioned within the hydration backpack containing a solvent;
a housing attached on a shoulder strap of the hydration backpack; the housing in fluid communication with the reservoir via an inlet tube attached to one end of the housing, wherein the housing is configured to house one or more cartridges;
each cartridge configured to store a solute, wherein each cartridge is in fluid communication with the housing via a mixing interface positioned on each cartridge;
an outlet tube attached to an opposing end of the housing, and in fluid communication with the housing, wherein the cartridge is pressurized to allow the solute to be extruded through the mixing interface, thereby dissolving the solute with the solvent within the housing; and
a bite valve distally positioned to the outlet tube configured to be suctioned by a user, wherein the dissolved solution in the housing is transferred to the user's mouth.

2. The apparatus of claim 1, wherein the solvent is water.

3. The apparatus of claim 1, wherein the solute is a nutritional supplement, or a non-nutritional supplement, or concentrated food, or an energy producing substance, or an alcohol, or a fluid substance, or a gas phase substrates, or carbon dioxide or hydrogen.

4. The apparatus of claim 1, wherein the mixing interface is an opening, wherein the solute is extruded from the cartridge via the opening due to the pressurized cartridge in the housing.

5. The apparatus of claim 1, wherein the cartridge wall is made of metal.

6. The apparatus of claim 1, wherein the mixing interface is a release valve, wherein the solute is extruded from the metallic cartridge via the release valve by the pressurized cartridge in the housing.

7. The apparatus of claim 6, wherein the cartridge wall is coated with a non-corrosive material.

8. The apparatus of claim 1, wherein the cartridge wall is made from a group of materials comprising one of polymeric and elastomeric materials.

9. The apparatus of claim 8, wherein the mixing interface is a discharge orifice, wherein the solute is extruded from the cartridge via the discharge orifice by the pressurized cartridge in the housing.

10. The dispenser of claim 1, wherein the inlet tube is attached to the end of the housing via an inlet nipple, and the outlet tube is attached to the opposing end of the housing via an outlet nipple.

11. The dispenser of claim 10, wherein the inlet nipple and outlet nipple comprises ridges, wherein the ridges are configured to facilitate snug fitting of the inlet tube and the outlet tube to the inlet nipple and outlet nipple.

12. The dispenser of claim 1, further comprising a cartridge holder defined by the housing configured to receive and position one or more cartridges.

13. A mixing and dispensing apparatus configured to be used in a bottle, the mixing and dispensing apparatus comprising:
a reservoir positioned within the bottle containing a solvent;
a housing attached on a cap of the bottle; the housing in fluid communication with the reservoir via an inlet tube attached to one end of the housing, wherein the housing is configured to house one or more cartridges;
each cartridge configured to store a solute, wherein each cartridge is in fluid communication with the housing via a mixing interface positioned on each cartridge;
an outlet of the cap attached to an opposing end of the housing, and in fluid communication with the housing, wherein the cartridge is pressurized to allow the solute to be extruded through the mixing interface, thereby dissolving the solute with the solvent within the housing, wherein the outlet of the cap is configured to be suctioned by a user, wherein the dissolved solution in the housing is transferred to the user's mouth.

14. The apparatus of claim 13, wherein the solvent is water.

15. The apparatus of claim 13, wherein the solute is a nutritional supplement, or a non-nutritional supplement, or concentrated food, or an energy producing substance, or an alcohol, or a fluid substance, or a gas phase substrates, or carbon dioxide or hydrogen.

16. The apparatus of claim 13, wherein the outlet of the cap is a mouthpiece of the cap.

17. The apparatus of claim 13, wherein the mixing interface is a one-way valve, wherein the solute is extruded from the cartridge via the one-way valve by the pressurized cartridge in the housing.

18. The apparatus of claim 13, wherein the cartridge wall is made of metal.

19. The apparatus of claim 18, wherein the cartridge wall is coated with a non-corrosive material.

20. The apparatus of claim 13, wherein the cartridge wall is made from a group of materials comprising one of polymeric and elastomeric materials.
